(19) United States
(12) Patent Application Publication
(10) Pub. No.: US 2019/0052661 A1
(43) Pub. Date: Feb. 14, 2019

(54) SYSTEMS AND METHODS FOR PREVENTING FRAUD

(71) Applicant: Vishal Anand, Bangalore (IN)

(72) Inventor: Vishal Anand, Bangalore (IN)

(21) Appl. No.: 15/674,187

(22) Filed: Aug. 10, 2017

(51) Int. Cl. H04L 29/06

(52) U.S. Cl. CPC H04L 63/1433; H04L 63/06; H04L 63/083

(57) ABSTRACT

A computer-implemented method of fraud detection comprising receiving a user identification, a standard authentication key, and an alternative authentication key associated with a user. The method includes storing the standard and alternative authentication keys in a user profile associated with the user identification, and storing a contingent action corresponding to the alternative authentication key. The method includes receiving an authorization request including the user identification and an authentication input, and comparing the authentication input with the standard authentication key and the alternative authentication key in the user profile. The method includes determining that the authentication input matches the alternative authentication key. Based on the determination that the authentication input matches the alternative authentication key, the method includes initiating the contingent action stored in the user profile corresponding to the alternative authentication key. The method may include determining if the authorization request matches a third party fraud alert.

### FIELD OF THE INVENTION

The invention relates to systems and methods for monitoring and mitigating fraudulent activity online.

### BACKGROUND

Traditionally, the systems and software allowing users to conduct online activity generally lack any means by which to determine whether the person engaging in the activity is doing so voluntarily. So long as the system receives proper user credentials or other authorization information, it will allow the activity to proceed. Increasingly, however, a person's authorization information may be used to enter into online activities without that person's consent. For example, an online user may be forced to enter his or her authorization information under duress. In such scenarios, traditional systems have no way to make determinations as to whether the activity is voluntary outside of merely assessing the provided authorization information.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the elements of an embodiment of a system that includes a system for monitoring and preventing fraud as disclosed herein;

FIG. 2 is a block diagram illustrating system elements for an embodiment of a system for monitoring and preventing fraud in accordance with the current disclosure;

FIG. 3 is a block diagram illustrating system elements for another embodiment of a system for monitoring and preventing fraud in accordance with the current disclosure;

FIG. 4 is a block diagram illustrating system elements for another embodiment of a system for monitoring and preventing fraud in accordance with the current disclosure;

FIG. 5 is a flowchart of a method of monitoring and preventing fraud in accordance with the current disclosure;

FIG. 6 is a flowchart of another method of monitoring and preventing fraud in accordance with the current disclosure;

FIG. 7 is a flowchart of another method of monitoring and preventing fraud in accordance with the current disclosure.

FIG. 8 is a flowchart of another method of monitoring and preventing fraud in accordance with the current disclosure

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method of fraud detection. The method may comprise receiving a user identification, a standard authentication key, and an alternative authentication key associated with a user. The method may include storing the standard and alternative authentication keys in a user profile associated with the user identification, and storing a contingent action corresponding to the alternative authentication key. The method may include receiving an authorization request including the user identification and an authentication input, and comparing the authentication input with the standard authentication key and the alternative authentication key in the user profile. The method may include determining that the authentication input matches the alternative authentication key. Based on the determination that the authentication input matches the alternative authentication key, the method may include initiating the contingent action stored in the user profile corresponding to the alternative authentication key.

In another embodiment, the disclosure describes a computer-implemented method of fraud detection. The method may comprise receiving, via a digital communication network, a user identification, a standard authentication key, a first alternative authentication key, and a second alternative authentication key all associated with a user. The method also includes storing, via one or more processors, the standard authentication key, the first alternative authentication key, and the second alternative authentication key in a user profile associated with the user identification. The method may include assigning, via the one or more processors, a first contingent action corresponding to the first alternative authentication key and a second contingent action corresponding to the second alternative authentication key, and storing, via the one or more processors, the first contingent action and the second contingent action in the user profile associated with the user. The method may include receiving, via the digital communication network, an authorization request including the user identification and an authentication input. In response to the authorization request, the method may include comparing, via the one or more processors, the authentication input with the standard authentication key, the first alternative authentication key, and the second alternative authentication key included in the user profile. The method may also include determining, via the one or more processors, that the authentication input matches one of the first alternative authentication key or the second alternative authentication key. Based on the determination that the authentication input matches one of the first alternative authentication key or the second alternative authentication keys, the method may include initiating, via the one or more processors, the first contingent action stored in the user profile when the authentication input matches the first alternative authentication key, and initiating, via the one or more processors, the second contingent action stored in the user profile when the authentication input matches the second alternative authentication key.

In another embodiment, the disclosure describes a computer-implemented method of fraud detection. The method may comprise receiving, via a digital communication network, a user identification for a user, a standard authentication key, baseline biometric data for the user, and a risk threshold level set by the user. The method may include storing, via one or more processors, the standard authentication key, the baseline biometric data for the user, and the risk threshold level in a user profile associated with the user identification. The method may include storing, via the one or more processors, a contingency action in the user profile. The method may include receiving, via the digital communication network, an authorization request including the user identification, an authentication input, and a biometric input for the user. In response to the authorization request, the method may include comparing, via the one or more processors, the authentication input with the standard authentication key. The method may include determining, via the one or more processors, that the authentication input matches the standard authentication key. In response to the determination that the authentication input matches the standard authentication key, the method may include determining, via the one or more processors, that the biometric input for the user exceeds the risk threshold level in the user profile associated with the user. In response to the determination that the biometric input for the user exceeds the risk threshold level in the user profile associated with the user, the method may include initiating, via the one or more processors, the contingent action stored in the user profile.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The fraud detection and monitoring system described herein may provide protection to a user against involuntary access to protected accounts and other content. The system may determine that a user is entering or providing authentication information while under duress, triggering a “panic” state with predefined courses of action. In some embodiments, a user may set up various levels of panic states with varying corresponding reactions based on the nature of the duress. For example, a user may set up predetermined rules that will limit access to the account being accessed, or take other contingent actions as deemed appropriate by the user, the system, or defaults. In some embodiments, the user may set up both the types of conditions for which the system will monitor, the contingent actions to take, and the type of user input that will trigger those actions. Possible, non-limiting, contingent actions the system may take upon receiving a panic state indication include locking the account, denying access to the account, allowing access but limiting activity, allowing access once but subsequently locking the account, trigger increased risk rules to evaluate the requested activity, etc. In an increasingly paperless world where a person's identity and assets are increasingly in digital form accessible online via authentication inputs, protection against fraudulent access to the accounts holding this information and performing transactions will become increasingly important.

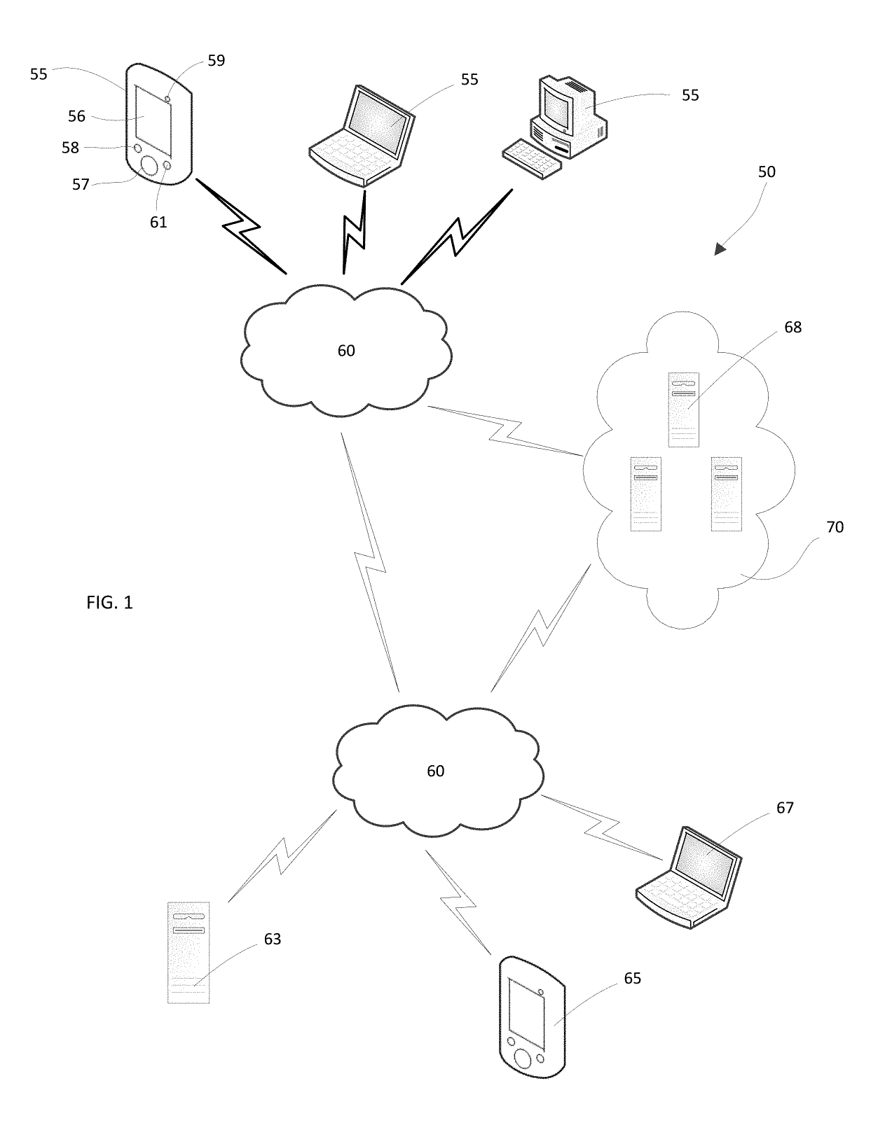

A high level illustration of some of the elements in a sample computing system 50 that may be physically configured to implement the fraud detection and monitoring system is illustrated in FIG. 1. The system 50 may include any number of user computing devices 55, such as smart phones or tablet computers, mobile computing devices, wearable mobile devices, desktop computers, laptop computers, or any other computing devices that allow users to interface with a digital communications network, such as digital communication network 60. Connection to the digital communication network 60 may be wired or wireless, and may be via the internet or via a cellular network or any other suitable connection service. Monitoring servers 68 may also be connected via the digital communication network 60. The monitoring servers may be a single server 68 or may be a plurality of monitoring servers making up a cloud of monitoring servers 70. In some embodiments, one or more third party computing devices 63, 65, 67 may also be connected to the digital communication network 60 allowing digital communication between the user computing devices 55, the monitoring servers 70, and the third party computing devices 63, 65, 67. The third party computing devices 63, 65, 67 may be associated with any of a variety of entities, including a merchant, a bank, a payment gateway, a content provider, etc.

In one embodiment, the user computing device 55 may be a device that operates using a portable power source, such as a battery. The computing device 55 may also have a display 56 which may or may not be a touch sensitive display. More specifically, the display 56 may have a capacitance sensor, for example, that may be used to provide input data to the computing device 55. In other embodiments, an input pad 57 such as arrows, scroll wheels, keyboards, etc., may be used to provide inputs to the computing device 55. In addition, the computing device 55 may have a microphone 58 which may accept and store verbal data, a camera 59 to accept images and a speaker 61 to communicate sounds. In other embodiments, the user computing device 55 may have other types of sensors, such as biometric sensors, that may receive user input of biometric indicators including heart rate, eye dilation, breathing rate, blood pressure, perspiration rate, facial expression, etc.

In some embodiments, the monitoring servers 68 may be associated with a monitoring service, and may monitor online activity of a user associated with the user computing device 55. Specifically, software may be included on the user computing device 55 allowing access to at least some of the user's online activity so as to monitor for online activity where the user may be a victim of fraud or other involuntary activities. In some embodiments, the software may be an application through which a user may complete transactions, such as banking, money transfer, merchant purchases, etc. In some embodiments, the software may be an add-on to a web browser included on the user computing device 55 that monitors online activity via the browser. In some embodiments, the monitoring service's software may be an application installed on the user computing device 55 that monitors the use of other applications on the user computing device, such as applications provided by a bank, online merchant, email service, payment provider, etc. In yet other embodiments, software included in the monitoring servers 70 may be used to monitor online activity of the user on a user computing device 55. In such embodiments, the monitoring service application may be programmed to only observe online activity or interactions with third party computing devices 65 that includes entering authentication inputs or other information to access content or data private to or at least controlled by the user. For example, a user computing device 55 may be used to access a bank account at an online bank associated with third party computing device 63. The user may have a bank account with the online bank that may require authentication information to access, such as a username and password. In some embodiments, the monitoring servers 70 may detect that a user is using a user computing device 55 to enter authentication information to access the user's account with the online bank and monitor the authentication inputs as further described below.

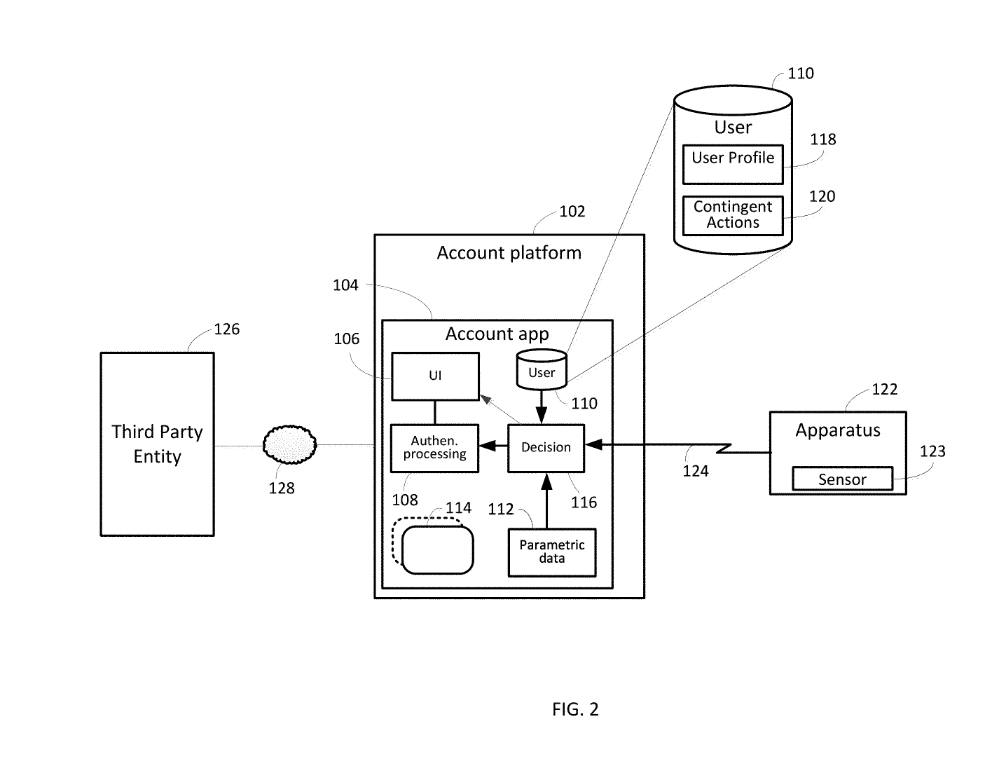

FIG. 2 is a block diagram generally illustrating another embodiment of a fraud detection and monitoring system that may limit access to an online account when a panic state have been detected. An account platform 102, in this embodiment, may be a personal computer or handheld device, such as a tablet or smart phone, or the user computing devices 55 in FIG. 1. In some embodiments, the account platform may be a purpose built computing device optimized for supporting the account platform functions.

The account platform 102 may have an account application 104 that is either installed and executed locally on the account platform 102, or may be a browser running client-side code supported by a merchant or issuer 126 connected via network 128. For example, the account application 104 may be an application or browser code provided by a merchant, issuer, or other third party entity 126 that supports a variety of online activities specific to that third party entity 126. While the third party entity 126 may be referred to as a merchant or issuer in the following description, other entities may be represented in that role, such as a payment gateway. The role may also be represented by other product and service providers, such as utilities, travel providers, content providers, banking providers, etc. While only the account application 104 is illustrated in FIG. 2, additional applications including other account applications may be supported simultaneously on the account platform 102. In various embodiments, applications from multiple merchants, banks, credit card issuers, wallet applications, and the like may reside on the account platform 102.

In various embodiments, the functions described below for fraud detection and monitoring may be duplicated in each of these additional applications, based on each application's particular requirements, or the hardware and software components may be shared among multiple applications using standardized application program interfaces (APIs) for initiating authentication inputs, invoking contingent actions, and clearing a contingent with proper permissions. In an embodiment, hardware sensors such as a computer mouse, keyboards, cameras, internal and external biometric sensors, microphones, or others, may be shared by each account application 104 capable of supporting fraud detection and monitoring. The account application 104 may include various components described below, although it will be apparent that numerous variations of the components explicitly depicted are capable of performing the activities described.

In an illustrative embodiment, the account application 104 may include a user interface 106 and an authentication processing module 108. The user interface 106 may support functions used to select items for purchase, transfer funds between accounts, make payments, read or compose emails, access a social media account, or other functions according to what is supported by the third party entity 126. The user interface 106 may also support setting up fraud detection and monitoring including panic state detection, contingent actions, and clearing a panic state with upon receiving proper permissions.

The authentication processing module 108 may support communication with the third party entity 126 and may include cryptographic processing, authentication, signing, or other functions. The authentication processing module 108 may act on data or instructions received from the decision module 116, as discussed in more detail below.

An account 114 (or multiple accounts) may be stored with the account application 104 and may be used to execute online activities and transactions, banking functions, loyalty functions, identity confirmation, etc., as supported by the account application 104 and the associated entity 126. In various embodiments, the account 114 may be or include a personal account number (PAN), a tokenized card number, or another account reference, such as account login credentials (username, password or phrase, etc.).

A user data module 110 may be used to store information related to initiating panic states, as will be discussed more below. Parametric data 112 may be information used to interpret authentication key inputs as discussed in further detail below, such as username/password entries, mouse movements, certain biometric data including, but not limited to, time of day, ambient temperature, background noise, or data gathered via a camera. A decision module 116 may be used to determine, in view of the parametric data 112, whether a condition exists for which access to the account 114 should be limited, denied, or another contingent action should be taken.

The user data module 110 may include a user profile 118 that may include criteria used for determining whether a user associated with the user data module 110 is under sufficient duress to block or limit access to a particular account, or take some other contingent action. For example, the user profile 118 may include one or more standard and alternative authentication keys for the user, or threshold levels for pulse rate, skin moisture, blood pressure (when suitable sensors are available). The user profile 118 may include facial recognition patterns associated with normal activity as well as voice stress data used to analyze a stress level of the user by monitoring a speech pattern of an utterance made by the user. In one embodiment, the utterance may be predetermined word or phrase, such as “don't hurt me.” The user profile 118 may include information that is not strictly related to biometrics, such as speech recognition patterns for comparison to a trigger word or phrase such as “Emergency!” used to trigger contingency actions.

The user data module 110 may also include contingent actions 120 used to inform the decision module 116 or authentication processing module 108 as to how to handle different circumstances associated with fraud detection and prevention. For example, depending on how many data points are analyzed and how much a current reading differs from a threshold stored in the user profile 118, the contingent actions 120 may include capping the amount of a financial transaction using the financial instrument, capping a number of transactions allowed in a period of time (volume and velocity limits), denying any transaction using the account 114, or sending a message to the third party entity 126 or an intermediary to place a hold on all accounts associated with the user.

In another embodiment, the contingent actions 120 may include sending a message to the third party entity 126 to increase the risk rules used to authorize transactions. In various embodiments, the contingent action selected will remain in place until the observed condition is cleared or the panic state is canceled by the user or a third party using predetermined criteria. Storing the contingent actions 120 with the user data module 110 allows more flexible rules for instituting a panic state, but in other embodiments, the contingent actions 120 may not be user-specific and may cover a wider range of users or applications. In other embodiments, the contingent actions 120 may be stored at the third party entity 126, in the authentication processing module 108, or in the decision module 116. In embodiments described below, the entire user data module 110 may not reside on the account platform at all, but rather may be stored in a wallet account or other upstream entity.

In some embodiments, an apparatus 122 may provide a signal 124 used by the decision module 116 to determine whether to invoke a panic state, or to take other contingent actions. In some embodiments, the apparatus 122 may be a separate device such as a fitness monitor, smart watch, or camera while in other embodiments, the apparatus 122 may be integral to the account platform 102 and may be or include a sensor 123 such as a camera, microphone, fingerprint scanner, keyboard, mouse, or other sensor or input device. The parametric data 112 may provide information used by the decision module 116 to help interpret information received via the apparatus 122. For example, if the ambient temperature is 95 degrees, an elevated body temperature may be discounted when evaluating whether to activate contingency actions, or the lighting in the room may affect a camera's readings for facial recognition.

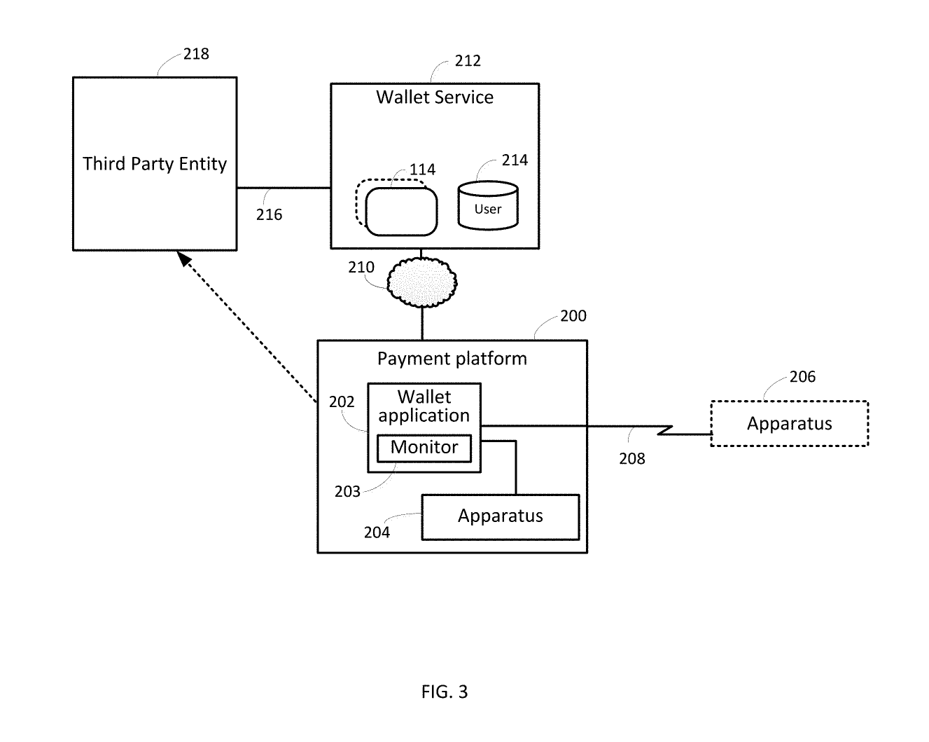

FIG. 3 is a simplified block diagram illustrating another embodiment for fraud detection and monitoring for an account and, more specifically, for a payment or financial account. In this embodiment, a payment platform 200, such as a smartphone, may host a wallet application 202 that is utilized to perform a transaction via a wallet service 212. The wallet application 202 may have a monitor 203 used in conjunction with fraud detection and monitoring. For example, in some embodiments, as a person (user) engages providing authentication information for the account, or engages in a purchase or a cash transfer using the wallet application 202, the monitor 203 may collect information via an apparatus 204. The apparatus 204 may be or include a biometric sensor, such as a fingerprint sensor or a pulse monitor, may be a camera that takes a photograph of a user's face, may be a keyboard or computer mouse for receiving user inputs, etc.

In various embodiments, collecting data from the apparatus 204 may be active or passive. That is, in one embodiment, the user may be prompted to use the apparatus 204 by placing a finger on a sensor or posing for a photograph, or to enter user authentication information such as a username and/or password key. In another embodiment, collecting the data may be performed passively, such as taking a photograph with a front-facing camera without indicating that the camera is active, or by listening for certain words or speech patterns.

Especially when data collection is explicitly sought, because the user may be under duress with a bad actor present, it may be desirable for the monitor to give an indication that authentication and screening was successful even when the monitor has detected a user input that will ultimately trigger contingency actions. That is, the monitor 203 may be programmed to indicate the screen or authentication process was successful even when either the monitor 203 or a downstream process may determine that the authentication input fails to satisfy a condition for full access to the account 114.

As discussed above, the user input may be data corresponding to pulse rate, blood pressure, facial stress, or a specific look, such as crossing the eyes. In other embodiments, the data collected may not be strictly biometric data but may include other explicit signals such as shaking the payment platform 200 or pressing a combination of buttons. In an alternate embodiment, the apparatus 204 may not be part of the payment platform 200 but instead may be an external apparatus 206 that communicates with the payment platform 200 via a network connection 208, such as Bluetooth®. For example, the external apparatus 206 may be a fitness tracker or smart watch capable of monitoring body conditions or even taking a photograph.

In the embodiment of FIG. 3, the wallet application 202 may pass the collected authentication data (or other indicator) to the wallet service 212 via the network 210. At the wallet service 212, stored user data 214, which may be the same as or similar to user data module 110 in FIG. 2, may be used in a comparison of the authentication data collected at the payment platform 200 to the baseline data stored with the user data 214. If the authentication data meets the criteria, the transaction may be approved and the user's account 114 is approved for use in the transaction with the third party entity 218 via network 216. In other embodiments, the wallet service 212 may return a token (not depicted) for use by the wallet application 202 for normal processing with a third party entity 218. In an embodiment, the token may include a ‘deny’ or ‘limit’ message along with the tokenized card number so that the third party entity 218, or other processor, applies the included information when processing the transaction or other account activity.

In another embodiment, the payment platform 200 or the external apparatus 206 may be shaken, rotated repeatedly, or taken through some other physical maneuver or pattern to set a flag that is read by the monitor 203 to indicate that the user is under duress. The monitor 203 may be preprogrammed with one or more motions that, if performed within a certain time period of an attempted transaction, will send an override message either explicitly, or by substituting a biometric reading that is known to cause a failed condition. For example, the monitor 203 may send a pulse reading of 150 when the known threshold is 100. In other embodiments, the user may have a plurality of preset authentication key entries, each of which provides a different signal to the wallet service 212 or third party entity 218 depending on a level of duress the user is experiencing. These authentication keys and possible contingency actions will be described in more detail below.

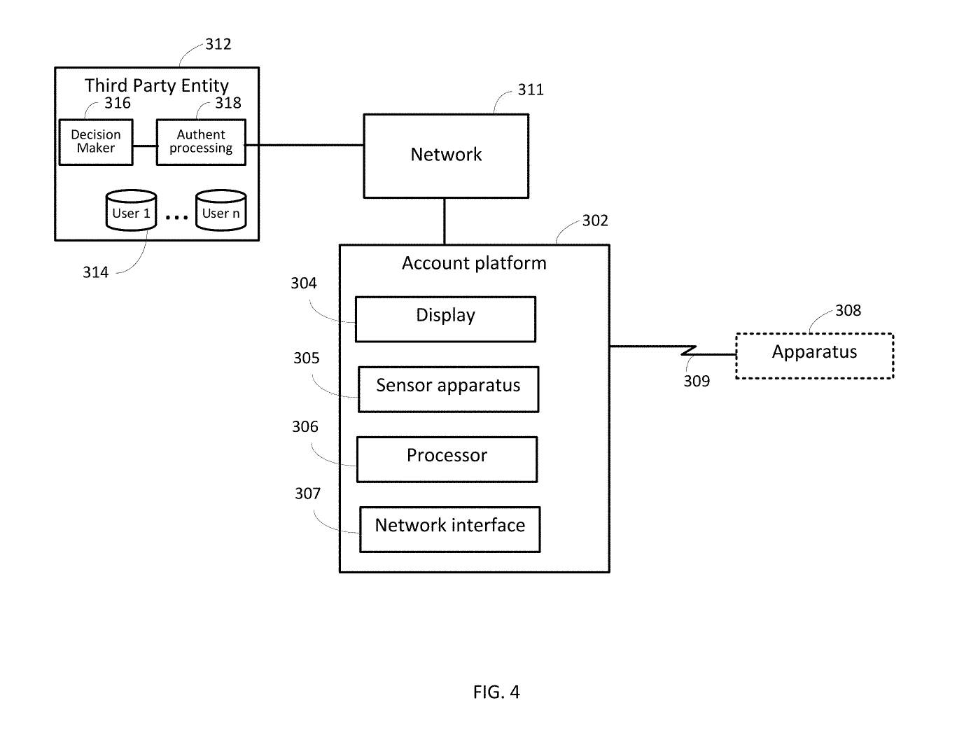

FIG. 4 is a block diagram illustrating another embodiment for implementing fraud detection and monitoring where the decision to implement a panic state may take place at a third party entity 312, such as an issuer, email hosting service, bank, or other similar authority. In this embodiment, authentication data may be collected at an account platform 302, such as a smart phone, a computer, an automatic telling machine (ATM), etc. The account platform 302 may have an integrated sensor apparatus 305 for collecting user input data such as a palm print reader, fingerprint reader, a camera, a keyboard, a computer mouse, etc. In such an embodiment, a palm or fingerprint reader may include additional capabilities such as pulse or skin moisture sensing. In another embodiment, the account platform 302 may be capable of collecting biometric data from a user's personal device 308, such as a smart phone or fitness tracker, via a wired or wireless connection 309.

The account platform 302 may include a display 304 that hosts a user interface for communication with a user and a sensor apparatus 305, such as a biometric sensor that captures a stress indicator during a transaction or a keyboard that receives user inputs. A processor 306 may be programmed to capture the stress indicator or keyed input and send it to a downstream entity, such as a third party entity 312, via a network interface 307.

The data from the account platform 302 may be transported via a network 311 to a third party entity 312 for authentication or approval. (For the sake of clarity, the illustrated process is greatly simplified and does not include other entities that may be involved in processing a transaction or other authentication approval.) In the illustrated embodiment, the data may include the stress indicator or keyed input collected related to the user. The third party entity 312 may then parse the data to separate the specific authentication information from the stress indicator. The authentication processing function 318 may begin the normal processing to determine if the transaction is capable of being executed, that is, PIN match, funds available, user ID match, etc. If the authentication process passes the basic tests, a decision maker function 316 may evaluate the stress indicator or other input data received against the user data 314 stored at the third party entity 312 in, for example, a profile database. To reiterate, the input data may include skin moisture, pulse, blood pressure, photographs, especially facial images, voice snippets for voice stress analysis, keyed user inputs, mouse movements, or more.

When the input data comparison satisfies the conditions associated with approval or authentication, a success message is passed back to the account platform 302 for continuing the account activity, e.g., dispensing cash, transferring funds, accessing email, making a purchase, etc. When the input data fails to satisfy the conditions associated with approval, a fail message may be sent to the account platform 302 and the transaction may be denied. The contents of the fail message, and ultimately, what is presented to the user on the account platform 302 may depend on any contingent action data stored in the user data 314. In various embodiments, the fail message may be designed to discourage a bad actor from further pursuing use of that financial instrument, such as “insufficient funds” rather than a simple “error” message. In other embodiments, when funds may actually be available, the transaction may be approved at a lower amount or even the full amount if below a value set according to the contingent action data. In other embodiments, but perhaps particularly when the full or partial transaction is approved, the response message from the third party entity may be routed to local authorities or at least to the location of the account platform 302 so that staff may be alerted to the situation or additional cameras may be concentrated in that direction.

The previous embodiments should not be viewed as being limited solely to the illustrated configurations. For example, the embodiment of FIG. 2 may include a wallet platform as depicted in FIG. 3, or the embodiment of FIG. 4 may include a monitor application in the account platform 302. The above are merely representative of other combinations of how alarm or biometric data are collected and where they are evaluated with respect to restricting financial instrument access for situational override access.

When setting conditions, the user may be able to input various biometric readings or other input data for which he or she would be considered under duress. For example, threshold values for a pulse rate, a blood pressure, a body temperature, or a skin conductivity (moisture level) may be entered by a user. These may be based on information from a fitness tracker or other health application that measures nominal and elevated levels for these values. In an embodiment, the user may reach a state of elevated levels, e.g., through exercise, and capture the readings available at that time.

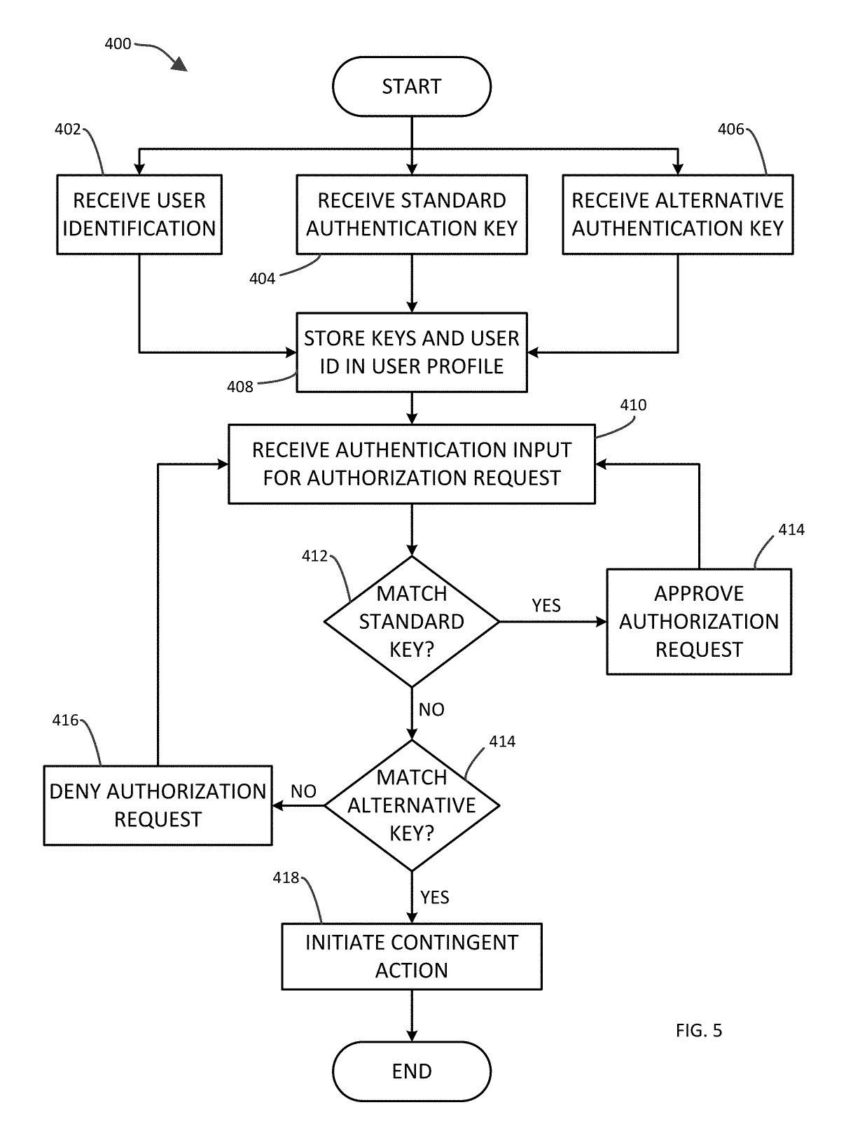

In some embodiments, the system may store user credentials, such as a user name and passwords, that indicate either a normal state (e.g., no duress), or one or more elevated alert states. For example, in one embodiment of a method 400 illustrated in FIG. 5, the system may, receive a user identification at block 402, receive a standard authentication key at block 404, and receive an alternative authentication key at block 406. In some embodiments, it is contemplated that multiple alternative authentication keys may be received for a user profile associated with a user identification. At block 408, the system may store the standard and alternative authentication keys along with the user identification in a user profile, e.g. the user profile 118 as described in reference to FIG. 2. In some embodiments, the user identification may indicate to the system which user profile in which the specific user's information may be stored. The standard authentication key may provide access to the user's account with no restrictions and without triggering any contingent actions or fraud monitoring. For example, a user may set a standard authentication key to be used under normal circumstances when entering an account voluntarily. The user may set its user profile to include one or more alternative authentication keys for use when entering the account in some involuntary manner, e.g., under physical duress or as the result of other fraud, such as ransomware. Contingency actions that may be taken by the system under varying alert levels are described in further detail below.

At block 410, the system may receive an authentication request that may include a user identification and an authentication key input. In some embodiments, the user identification may identify to the system which user's account is trying to be accessed. The user identification may be any of a variety of inputs, such as a typed username or user ID, a biometric reading such as finger print, retina scan, or facial recognition, voice identification, etc. The authentication key input may be an input supplied by the user to prove that the user should be granted access to the user account. For example, the authentication key input may be an alphanumeric entry pre-set or assigned to the user, a mouse movement, or any of a variety of user inputs. In some embodiments, the user identification and the authentication key input may be included in the same user input. For example, the system use a camera to perform facial recognition on the user, which may identify the user for the account being accessed and prove that the person trying to access the account has permission to access the account.

At block 412, the system may determine whether the authentication input received as included in the authentication request matches the standard authentication key stored in the user profile for the user associated with the received user identification. If the authentication input matches the standard authentication key, the system may, at block 414, approve the authentication request and grant access to the account. If the received authentication input does not match the standard key at block 412, the system may, at block 414, determine if the authentication input matches one or more alternative keys. If the authentication input does not meet the standard authentication key or one of the alternative authentication keys, the system may deny the authorization request. In some embodiments, the system may prompt the user to re-enter either or both of the authentication input of the user identification. If, at block 414, the received authentication input for the authorization request matches at least one of the one or more alternative authentication keys, the system may, at block 418, initiate one or more contingent actions in response to potential fraud detection. In some embodiments, the contingent action or actions to be taken upon receiving an alternative authentication key may be stored in the user profile. As described in further detail below, the contingent actions may be any number of actions based on the type of account at issue. For a bank account, one possible contingent action would be to deny access to the account or to deny the ability to transfer any money from the bank account.

Various types of user inputs are contemplated herein for use in providing user identification and/or the authentication input. In some embodiments, the apparatus 122 that the user may enter a user ID and/or authentication input may be an alphanumeric keyboard or keypad. The keyboard may be wired or wirelessly connected to a computing device 55 or account platform 102. In such embodiments, the user identification may be a unique username that the user may create to identify to the system which user profile to reference. The standard authorization key may be an alphanumeric password or pass phrase. As described above, when the user correctly enters the user's username and a password that matches the standard authorization key with the keyboard, the system may allow access to the account normally, with no contingent actions taken. If the user enters a password that matches the alternative authentication key, however, the system may initiate contingency actions. The alternative authorization key may have various forms and may be pre-set by the user. For example. The alternative authorization key may be a partially or completely different password than the standard authentication key. In some embodiments, the alternative authentication key may include the standard authorization key, but appended with a pre-set word or number, such as “help” or “911,” for example, to indicate a panic state. In other embodiments, the alternative authorization key may include a pre-set word interspersed within the standard authorization key. For example, if a user's standard authorization key is “password,” the alternative authorization key may be “phsewlrp” (“help” inserted into “password”). In other embodiments, the alternative authorization key may be repetitive entries of the standard authentication key with or without spaces, or may be a series of entering the password, then deleting the password, then entering the password again, for a pre-set number of iterations. The various types of alternative authentication keys listed herein are non-limiting, and other types are contemplated.

In some embodiments, the apparatus 122 may include a computer mouse, track pad, touch pad, touch screen, or other selection control device. In such embodiments, the user may use the mouse to input a pre-set clicking pattern or pre-set shape with the mouse as an alternative authentication key or in combination with a password input. For example, a user may enter the standard authentication key that would otherwise provide normal account access, but combine that entry with a pre-set pattern of mouse-clicks. In one such embodiment, the user may set up the alternative authentication key to include clicking a pre-set number of times in the password entry field. In other embodiments, the user may set the alternative authentication key to include entry of a password and forming a pre-set pattern with the mouse pointer or on a touch pad. Of course, those of skill in the art would understand that many other user inputs with a keyboard, mouse, or combination of a keyboard and mouse could be used to set an alternative authentication key.

In some embodiments, the apparatus 122 may include a camera or other visual or light sensor that may monitor the user's face as the user provides the user identification and/or the authentication key. In some embodiment, the camera may allow the system to perform facial recognition to confirm whether the person attempting to access the account. Facial recognition may be used in lieu of other user ID entry types, or in combination with other types of authentication input. For example, in some embodiments, a user may provide a username and/or password with a keyboard, and the camera may use facial recognition as to determine whether user may be entering authentication information under duress. The system may take a photograph, series of photographs, or video of the user's face as a baseline reference input in a situation where the user is known not to be under duress. In some embodiments, the photographs or videos may be stored in the user profile 118 included in the standard authorization key or user identification. Subsequently, if a user then enters authentication information for the account but the system recognizes that the user's facial expression indicates fear or high stress, contingency actions may be triggered. In such embodiments, the user's baseline facial expression may be considered the standard authentication key, and the user's face under duress may be considered the alternative authentication key. In some embodiments, the system may store images of the user's face in the user profile each time the user accesses the account in order to build a more robust reference point for the user's facial expressions when not under duress. Similarly, in some embodiments, a microphone may be included in the apparatus 122 and used to provide a voice signature as a baseline, and listen for deviations from the baseline voice signature that may indicate a panic state.

Certain facial features, facial expressions, or voice signature features in both a panic state (e.g., under duress) and a normal state (e.g., not under duress) may be common across many people in a population. Thus, in some embodiments, the system may develop a database of common facial features or expressions that are most likely associated with a normal state, and most likely associated with a panic state. This way, the system may use machine learning techniques to improve its analysis of whether a user's face is indicating a panic state based on constantly updating data from other users.

In some embodiments, contingency actions taken by the system may vary based on a plurality of levels or tiers of the panic state. For example, the system may provide, and a user may set up, a user profile 118 that includes three tiers of panic states. Each tier of panic state may correspond to a different alarm level and a different contingency action. In some such embodiments, a higher alarm level may correspond with a more severe or restrictive contingency action. In some embodiments, the differing alarm levels may correspond to different types of threats to the user that should be met with specific contingency actions to best address the threat.

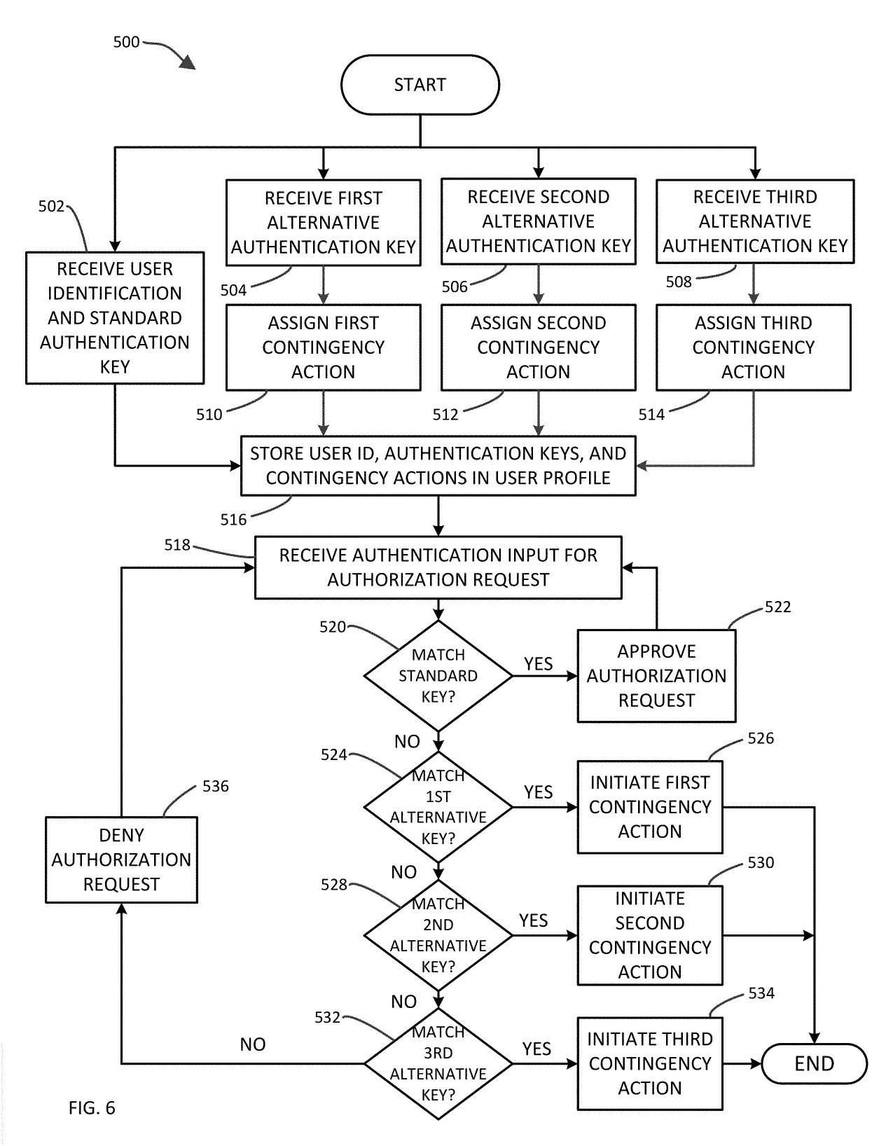

FIG. 6 illustrates an embodiment of a method 500 the system may implement to determine one of various alert levels and initiate contingency actions based on the alert level. At block 502, the system may receive the user identification and the standard authentication key. At block 504, 506, and 508, the system may receive a first alternative authentication key, a second alternative authentication key, and a third alternative authentication key, respectively. It should be understood that the user identification and authentication keys may be received via any of the processes described above, or with other appropriate mechanisms as would be understood by one skilled in the art. It should also be understood that, although three alternative authentication keys are shown here, more or fewer alternative authentication keys are also contemplated. At blocks 510, 512, and 514, the system may assign first contingency action, a second contingency action, and a third contingency action, respectively. The first contingency action may correspond with the first alternative authentication key, the second contingency action may correspond with the second alternative authentication key, and the third contingency action may correspond with the third alternative authentication key. In some embodiments, the first, second, and third contingency actions may be set automatically without the user. In other embodiments, the user may pre-select the actions that the system should take for each contingency action. For example, in one embodiment, the first contingency action may set to reject the current attempt to access the account, or reject the current transaction attempt using the account, but to leave the account unlocked and open to be accessed using the standard authentication key when entered. In some embodiments, such a first contingency action may be a Tier 1 alarm. The second contingency action may be set up as a Tier 2 alarm, and to reject the current attempt to access the account or to complete a transaction, and to lock access to the account either permanently or temporarily. In such embodiments, the user may initiate a separate process to unlock the account for subsequent use, such as by calling a help center, providing additional authentication or biometric data, or by providing an unlocking authentication key. The third contingency action may be set to a Tier 3 alert and may include approving the current account access or transaction, but locking the account from subsequent access or from performing further transactions. One example of when a Tier 3 alert may be useful is if a user is under immediate physical threat and being forced to access an account or complete a transaction. In such scenarios, it may be dangerous to the user to simply reject the current transaction or other account access in the short term, but may limit the loss from the attack by not allowing subsequent access or transaction once the current access or transaction is complete.

It should be understood that the contingency actions described herein are merely examples, and that many more types of contingency actions are contemplated. Some additional non-limiting examples include limiting a transaction amount for the current account access, providing a time-limit for account access, displaying a dummy depiction of a user account that shows false information about the contents of the account such as less money available for transactions, etc. In certain embodiments that may involve a recipient party to provide a product or service to a sender party, the contingency action may include locking payment in escrow until the sending party confirms that the recipient party has performed the recipient's portion of the transaction (e.g., delivered a purchased product or service). In such embodiments, the sender may enter an alternative authentication key to trigger the system to implement the escrow. In such embodiments, the sender may then confirm performance using any suitable pre-defined mode of bi-party exchange, such as biometric signature upon delivery, or confirming performance online. Each contingency action may be pre-set by the user and correspond to a particular alternative authentication key that may be entered by the user as appropriate for the particular scenario.

Referring again to FIG. 6, at block 516, the system may store the user ID, authentication keys, and corresponding contingency actions in the user profile 118. At block 518, the method may include receiving an authentication input for an authorization request. In some embodiments, the authorization input may include a separate user identification input and authentication key input, and in some embodiments (e.g., facial recognition, as described above), the user identification input and the authentication input may be the same or at least part of a single input. In some embodiments, the authentication input may include an alphanumeric password, PIN, or passphrase. At block 520, the method may include determining whether the authentication input matches the standard authentication key as stored in the user profile 118 indicated by the input user identification. If the authentication input matches the standard authentication key, then the system may approve the authorization request at block 522. If the authentication input of the authorization request does not match the standard authentication key, then the system may, at block 524, determine whether the authentication input matches the first alternative key. If so, the method may include, at block 526, initiating the first contingency action. If the authentication input does not match the standard authentication key or the first alternative authentication key, then the method may include, at block 528, determining whether the authentication input matches the second alternative authentication key. If so, the method may include initiating the second contingency action at block 530. If the authentication input does not match the standard authentication key, the first alternative authentication key, or the second alternative authentication key, the method may include determining whether the authentication input matches the third authentication key at block 532. If yes, the method may include initiating the third contingency action at block 534. If not, and the authentication key is determined not to match any of the standard authentication key, the first alternative authentication key, the second alternative authentication key, or the third alternative authentication key, the method may include denying the authorization request at block 536.

In some embodiments, a panic state may be detected based on one or more factors that exceed a risk threshold. The threshold may be determined based on a level of risk tolerance chosen by a user, or chosen based upon the type of account being accessed. For example, a bank account or account for money transfers may have a relatively low threshold for triggering a panic state due to the nature of the account. In contrast, an email or social media account may have a relatively high threshold for triggering a panic state due to the relatively limited risk of attack and damage done due to fraudulent or involuntary access. In one embodiment of the system, the apparatus may include sensors 123 such as a heart rate monitor, a fingerprint reader, a camera for facial recognition, and a microphone for receiving inputs from the user. The user profile 118 for a user may include a baseline for each biometric and other input. For example, the user profile 118 may include the heart rate, facial expressions, voice signature, etc., for the user in a normal, non-panic state. In some embodiments, each input metric may be a factor contributing to a risk index evaluated by the system when a user attempts to access an account. In such embodiments, a contingency action may be triggered when the risk index exceeds the risk threshold level. In some embodiments, a user profile may include multiple risk threshold levels, with a different contingency action corresponding to each risk threshold.

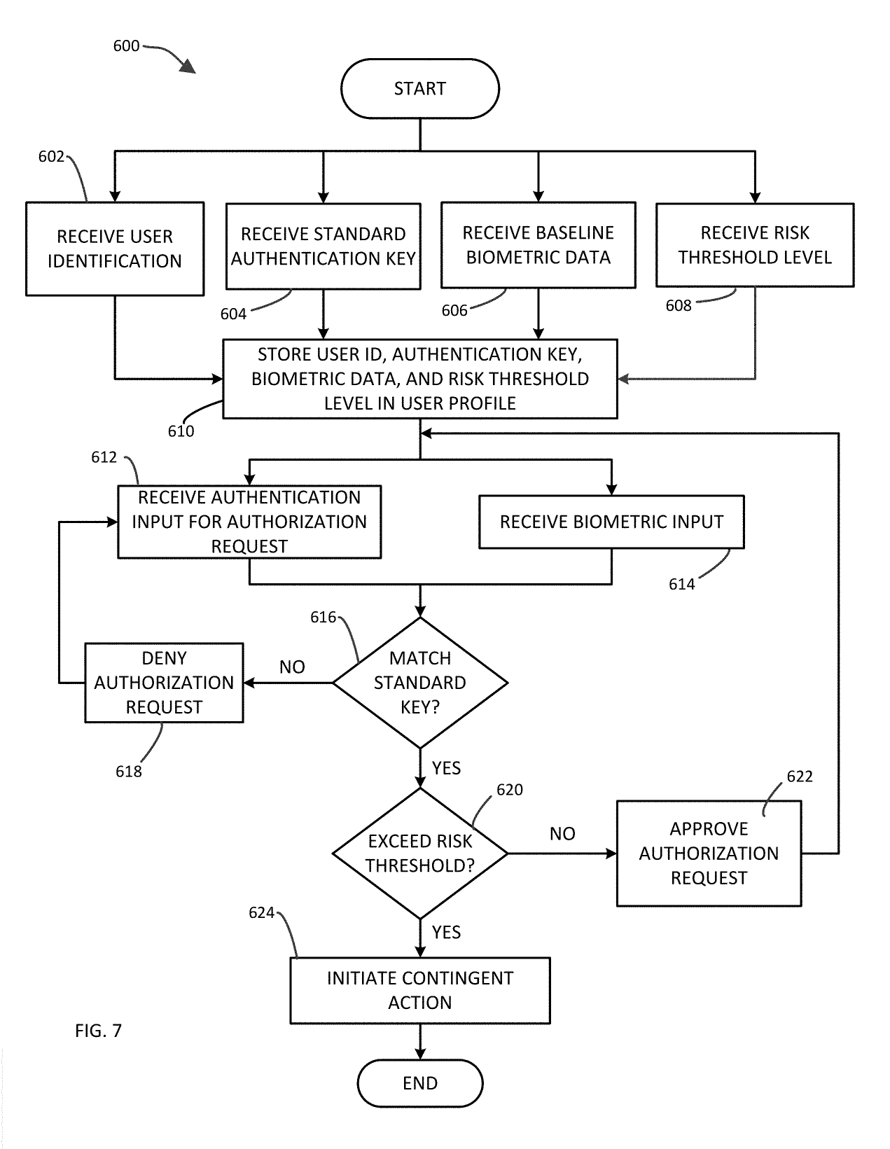

FIG. 7 illustrates a method 600 the system may implement to detect fraud by monitoring risk factors that may indicate the user is under duress or that the recipient of a transaction is attempting fraud. At block 602, the method may include receiving a user identification that may correspond to a user profile of the user. At block 604, the method may include receiving a standard authentication key that may be received by the system to authenticate the user's access. Similar to embodiments described above, the user identification and the authentication key may be the same, such as when using facial recognition. At block 606, the method may include receiving baseline biometric data for the user through an apparatus 122 communicating with a user device 55 or account platform 102. For example, the method may include receiving baseline data of a user's heart rate, facial expressions, skin moisture levels, voice signature, or any other data specific to the user and useful to determine a user's current stress levels, etc. Each piece of biometric data may be a risk factor considered by the system to determine whether the user is under duress. In some embodiments, sensors 123 may also indicate other environmental conditions at the time a user is providing inputs, such as room temperature, humidity, etc.

In some embodiments, each factor may be converted into a risk index level, and combined with risk index levels from other risk factors. For example, a user's baseline heart rate may be 65 beats per minute, which may be set to a risk index level of zero. If, when subsequently providing authentication inputs the user's heart rate is higher, such as 85, the system may apply an elevated risk index level to that factor. The system may then combine the risk index levels for each risk factor to determine an overall risk index level. In some embodiments, other environmental factors may influence the risk index level interpretation as well, such as room temperature, time of day, etc.

At block 608, the method may include receiving a risk threshold level either as determined by the user or set as a default. The risk threshold level may be risk level over which the user decides that contingency action should by initiated. In some embodiments, a risk index level identified by the system that exceeds the risk threshold level may indicate that a high likelihood that the user is under duress and therefore not accessing the account voluntarily. Some embodiments may include multiple levels of risk threshold levels with different contingency actions for each threshold. For example, a user may set a first risk threshold level at a risk level index of 5, a second risk threshold level at a risk level index of 7, and a third risk threshold level at a risk level index of 9. In such an embodiment, the user may choose a first contingency action to be initiated when exceeding the first risk threshold level to be simply rejecting the current account access attempt or rejecting the current transaction attempt. The user may choose a second contingency action to be initiated when exceeding the second risk threshold level to be rejecting the current account access attempt and locking the account to subsequent access attempts. The user may additionally choose a third contingency action to be initiated when exceeding the third risk threshold level to be allowing the current account access or transaction to proceed, but to limit additional access to the account and/or limit the amount of a transaction or subsequent transactions, or to send a message to a third party entity reporting the likely fraudulent account access. In such embodiments, the user may have the ability to set risk threshold levels depending on the user's risk tolerance or depending on how sensitive the account may be.

Referring again to FIG. 7, at block 610, the method may include storing the user identification, authentication key or keys, baseline biometric data, and risk threshold level or levels in a user profile corresponding to the user identification. At block 612, the method may include receiving an authentication input for an authorization request in attempt to access the user account. At block 614, the method may also include either subsequently or simultaneously receiving biometric input from the user as described above, so as to have a reading of the user's biometric data during the account access attempt. At block 616, the method may include determining whether the authentication input included in the authorization request matches the standard authentication key for the user profile corresponding to the user identification. If the input does not match the standard authentication key, the method may include denying the authorization request at block 618. If the authentication input matches the standard authentication key, then the method may include, at block 620, determining whether the risk index level indicated by the biometric inputs exceed the risk threshold level or levels included in the user profile. If the risk index level does not exceed the risk threshold level, the method may include approving the authorization request at block 622. If the risk index level determined from the biometric inputs exceeds the risk threshold level, the method may include, at block 624, initiating a contingency action or actions.

In some embodiments, the system may include monitoring other fraud attempts and successes for other users accounts across the system. In such embodiments, the system may use machine learning techniques to identify common factors across different users that may better inform a determination that any given user may be under duress. For example, it is contemplated that certain account services hosted by certain third party entities may become more vulnerable to hacking or ransomware attacks at different times. For instance, a particular bank, credit card provider, or email service may be the target of a ransomware actor. In such scenarios, the system may recognize that one or more users of a particular account service have been targeted, which may influence the system's decision as to whether a user attempting to access an account is under duress. In such embodiments, the system may add these factors to the risk level index in determining whether a risk threshold level is exceeded. In other words, the system may determine that a fraudulent account access attempt based at least on any combination of: 1) authentication key input; 2) biometric data inputs of the user and the user's environment; and 3) overall system information regarding other fraudulent account access attempts.

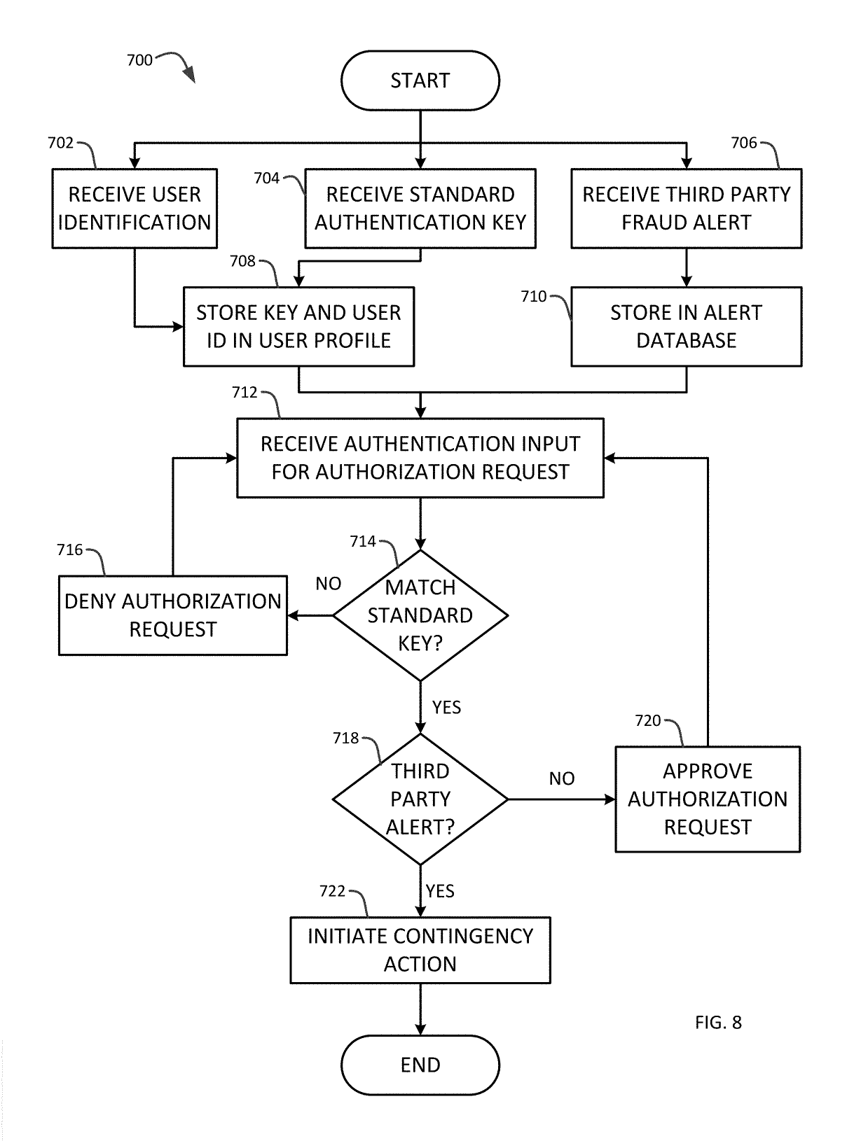

FIG. 8 illustrates another embodiment of a method 700 for detecting and monitoring fraud that may operate alone or in conjunction with the methods described above. In this embodiment, the method may include receiving a user identification at block 702 and receiving a standard authorization key for the user at block 704. The process of receiving these inputs may be similar to those described above with reference to previously described embodiments. The method may include, at block 708, storing the standard key and the user identification in a user profile associated with the user. The method may also include receiving a third party fraud alert at block 706. The third party fraud alert may be received in a number of contexts. For example, as described in further detail in the examples below, users may report that certain prior payment or other account activity was fraudulent after payment was made. While this reporting may not always result in the particular user recovering the defrauded accounts or information, the system may store the third party fraud alert in a fraud database (or other suitable location) at block 710. The stored alerts in the fraud database may then be reference in subsequent account activity by other users to aid in detecting further fraudulent activity.

At block 712, the method may include receiving authentication input for an authorization request to access an account or perform other online activity (e.g., payment transaction or purchase). At block 714, the method may include determining if the standard authorization key matches the authentication input provided by the user. If not, the method may include denying the authorization request at block 716. If the authentication input matches the standard authentication key, at block 718, the method may include determining whether the request involves anything that has been previously reported and stored as a third party fraud alert in the fraud database. For example, recipients for prior-reported fraudulent transactions or payments may be stored and referenced at block 718. If nothing in the authorization request includes information from a third party fraud alert, the method may include approving the authorization request at block 720. If, however, in the authorization request includes information from a third party fraud alert, the method may include, at block 722, initiating contingency actions. The contingency actions may be any of the various types of contingency actions described herein. In some embodiments, it is contemplated that the third party fraud alerts and the determination as to whether a current activity is fraudulent may include assessing multiple factors and risk threshold levels such as described in reference to FIG. 7.

The following are examples of situations in which one, several, or a combination of the methods described herein may be effective at detecting and monitoring attempts to fraudulently access accounts through duress, deception, or some other means. These examples are not meant to be limiting in any way, and one skilled in the art will understand how the examples may be illustrative of other scenarios in which the disclosed methods and systems may be implemented. In one example, a first sender may attempt to enter into a transaction with a first recipient. The first sender may, for any of a variety of reasons, provide a fraud alert to the system that the transaction with the first recipient may be fraudulent. The first sender may provide the alert in a variety of ways, including by using alternative authentication keys or through biometrics, as described above, or by explicitly reporting such fraudulent activity directly to a payment or account platform, wallet service, third party entity, etc., such as those described in FIGS. 2-4. In some embodiments, the system may make attempts to validate the fraud alert by examining prior activities by either or both of the first sender and recipient. Once the fraud alert is received and validated, the system may then record the parties involved, conditions of the transaction, etc., and store that information in a fraud database or other suitable location. Subsequently, a second sender may attempt to enter a transaction or other interaction with the first recipient. In some embodiments, the system may search the fraud database and determine that the first recipient had been flagged by a third party alert as likely fraudulent. In some embodiments, the system may block the transaction from the second sender as a fraudulent or likely fraudulent transaction. It is contemplated that this example scenario may also occur in the context of the method described with regard to FIG. 7, where the third party alert may be a factor considered by the system when determining whether a risk threshold level has been exceeded. Additionally, in some embodiments, the potential recipient (e.g., recipient for crowd-funded campaigns, merchants, etc.) may be pre-validated by the system as being trustworthy recipients and thereby reduce the probability that the system would determine that recipient to be fraudulent.

In another non-limiting example, the methods described herein may be used to protect against or mitigate fraudulent activities relating to cybersquatting. For instance, a bad actor may take unauthorized possession of a website domain, transfer it from one host provider to another, and list the domain name for sale. The rightful owner may decide to simply purchase the domain name back from the bad actor to recover it. However, in some instances, the rightful owner may not trust the bad actor to actually turn over ownership of the domain name even after providing payment. In such a scenario, the rightful owner may use an alternative authorization key to alert a payment or account platform, wallet service, third party entity, etc., such as those described in FIGS. 2-4, that the payment is based on fraudulent activity and contingency actions may be initiated. For example, in the cybersquatting scenario, one contingency action may be to escrow the payment and make the payment conditional upon the bad actor actually delivering ownership of the stolen domain name. In other examples, the system may demand further validation from the bad actor recipient in order to complete the payment. The system may also store the fraud alert and information about the bad actor recipient for reference in subsequent activity with different fraud victims. Subsequently, if the same bad actor attempts to sell another stolen domain name, the system may block payment to that bad actor recipient even if the party intending to provide payment does not know that fraud has taken place. Because the bad actors would be blocked from receiving payment, the bad actors may be deterred from future similar behavior. In some embodiments, legitimate actors verified by a payment or account platform, wallet service, third party entity, etc., may be awarded a clearing certificate that may be referenced to avoid duplicate verification checks.

In another example, the system may include a way for users to report fraud post-payment in order to build additional data points for detecting fraud. For instance, a user may be induced into making payments to a bad actor recipient for certain cyber-fraud attacks, e.g., fake lottery winners, etc. Even if the initial user is induced into the fraudulent payment, the user may report the fraud alert to a payment or account platform, wallet service, third party entity, etc., for reference in determining subsequent fraudulent activities. In some embodiments, the fraud alerts may be submitted within a certain time period after the occurrence of the fraudulent activity.

In another example, the system may be used to detect or prevent fraud due to overcharging or overbilling. For instance, in a retail or online setting, a bad actor recipient may fraudulently add unauthorized amounts of money to otherwise legitimate payments and cause the unauthorized amount to be routed to the bad actor recipient. The system may recognize that certain recipients are receiving large numbers of relatively small payments and flag the activity for further investigation. Once the activity has been flagged, the system may pre-check requested activity prior to authorizing transactions in order to determine whether any recipients of the payments have been flagged as fraudulent actors. In some embodiments, legitimate recipients (e.g., legitimate crowdsourcing efforts or charitable contributions) may be pre-assessed to determine that even large numbers of small payments should be authorized. In some embodiments, third party entities (such as merchants) may pay for access to the data gathered using the system in order to better protect their customers against fraudulent activity occurring in their stores or websites.

In each of the embodiments described above, various processes may be used to clear the panic state or to reset the contingency actions. The clearance may be conducted locally at the account platform 102 using either a code or verbal instruction entered into the account application 104. In another case, the account application 104 may retake the input data readings and determine that the new readings or inputs are below the user profile data 118 in order to clear the panic state. The panic state may also be cleared by simply logging into an online account at a third party entity 126, or wallet service 212, or in some cases, entering a code after logging into one of these accounts. In other cases, where a higher level of risk to a user may be a concern, clearing the override may require intervention by a third party as proof that the user is no longer in a high-stress state or no longer under duress. For example, a friend or relative, bank employee, etc., may have to enter a code to clear the panic state, for example, by entering the code into the user's account application 104.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 10 and the methods described herein may be configured to provide real-time incentive information to service providers and execute near-immediate payout splits upon service completion. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method of fraud detection, the method comprising:
receiving, via a digital communication network, a user identification, a standard authentication key, and an alternative authentication key all associated with a user;
storing, via one or more processors, the standard authentication key and the alternative authentication key in a user profile associated with the user identification;
storing, via the one or more processors, a contingent action in the user profile corresponding to the alternative authentication key;
receiving, via the digital communication network, an authorization request including the user identification and an authentication input;
in response to the authorization request, comparing, via the one or more processors, the authentication input with the standard authentication key and the alternative authentication key included in the user profile;
determining, via the one or more processors, that the authentication input matches the alternative authentication key; and
based on the determination that the authentication input matches the alternative authentication key, initiating, via the one or more processors, the contingent action stored in the user profile corresponding to the alternative authentication key.

2. The method of claim 1, wherein the authentication input is an alphanumeric password entered by the user.

3. The method of claim 1, wherein the user identification, the standard authentication key, and the alternative authentication key are each associated with a user account of the user, and wherein the contingency action includes rejecting access to the user account.

4. The method of claim 1, wherein the user identification, the standard authentication key, and the alternative authentication key are each associated with a user account of the user, and wherein the contingency action includes allowing access to the user account and limiting account capabilities.

5. The method of claim 1, wherein the standard authentication key is a first alphanumeric password set by the user, and the alternative authentication key is a second alphanumeric password set by the user.

6. The method of claim 1, wherein the standard authentication key is a first alphanumeric password set by the user, and the alternative authentication key is a second alphanumeric password set by the user, the second alphanumeric password including the first alphanumeric password.

7. The method of claim 1, wherein the standard authentication key is at least one baseline image a face of the user, and wherein the alternative authentication key is at least one additional image of the face of the user captured substantially concurrently with the receiving of the authorization request.

8. The method of claim 1, wherein the standard authentication key includes a baseline heart rate of the user, and the alternative authentication key includes a heart rate of the user that differs from the baseline heart rate of the user.

9. The method of claim 1, further comprising:
receiving, via the digital communication network, a third party fraud alert from a third party user;
determining, via the one or more processors, that the authorization request includes information matching information in the third party fraud alert; and
based on the determination that the authorization request includes information matching information in the third party fraud alert, initiating a second contingency action.

10. A computer-implemented method of fraud detection, the method comprising:
receiving, via a digital communication network, a user identification, a standard authentication key, a first alternative authentication key, and a second alternative authentication key all associated with a user;
storing, via one or more processors, the standard authentication key, the first alternative authentication key, and the second alternative authentication key in a user profile associated with the user identification;
assigning, via the one or more processors, a first contingent action corresponding to the first alternative authentication key and a second contingent action corresponding to the second alternative authentication key;
storing, via the one or more processors, the first contingent action and the second contingent action in the user profile associated with the user;
receiving, via the digital communication network, an authorization request including the user identification and an authentication input;
in response to the authorization request, comparing, via the one or more processors, the authentication input with the standard authentication key, the first alternative authentication key, and the second alternative authentication key included in the user profile;
determining, via the one or more processors, that the authentication input matches one of the first alternative authentication key or the second alternative authentication key; and
based on the determination that the authentication input matches one of the first alternative authentication key or the second alternative authentication keys, initiating, via the one or more processors, the first contingent action stored in the user profile when the authentication input matches the first alternative authentication key, and initiating, via the one or more processors, the second contingent action stored in the user profile when the authentication input matches the second alternative authentication key.

11. The method of claim 10, wherein the authentication input is an alphanumeric password entered by the user.

12. The method of claim 10, wherein the user identification, the standard authentication key, the first alternative authentication key, and the second alternative authentication key are each associated with a user account of the user, and wherein the first contingency action includes rejecting access to the user account and the second contingency action includes allowing immediate access to the user account and includes locking subsequent access to the user account.

13. The method of claim 10, wherein the standard authentication key is a first alphanumeric password set by the user, the first alternative authentication key is a second alphanumeric password set by the user, and the second alternative authentication key is a third alphanumeric password set by the user.

14. The method of claim 10, wherein the standard authentication key includes baseline biometric data for the user, the first alternative authentication key includes a first risk threshold level set by the user, and the second alternative authentication key includes a second risk threshold level set by the user.

15. The method of claim 14, wherein the baseline biometric data is a baseline heart rate of the user, the first risk threshold level is a first elevated heart rate of the user that is higher than the baseline heart rate, and the second risk threshold level is a second elevated heart rate of the user that is higher than the first elevated heart rate of the user.

16. The method of claim 15, wherein the first contingency action corresponds to a first alert level and the second contingency action corresponds to a second alert level.

17. A computer-implemented method of fraud detection, the method comprising:
receiving, via a digital communication network, a user identification for a user, a standard authentication key, baseline biometric data for the user, and a risk threshold level set by the user;
storing, via one or more processors, the standard authentication key, the baseline biometric data for the user, and the risk threshold level in a user profile associated with the user identification;
storing, via the one or more processors, a contingency action in the user profile;
receiving, via the digital communication network, an authorization request including the user identification, an authentication input, and a biometric input for the user;
in response to the authorization request, comparing, via the one or more processors, the authentication input with the standard authentication key;
determining, via the one or more processors, that the authentication input matches the standard authentication key;
in response to the determination that the authentication input matches the standard authentication key, determining, via the one or more processors, that the biometric input for the user exceeds the risk threshold level in the user profile associated with the user; and
in response to the determination that the biometric input for the user exceeds the risk threshold level in the user profile associated with the user, initiating, via the one or more processors, the contingent action stored in the user profile.

18. The method of claim 17, wherein the risk threshold level is a first risk threshold level and the contingency action is a first contingency action corresponding to the first risk threshold level, and wherein the method further comprises storing a second risk threshold level and a second contingency action in the user profile corresponding to the second risk threshold level.

19. The method of claim 17, wherein the baseline biometric data for the user includes at least a baseline heart rate.

20. The method of claim 17, wherein the biometric input for the user includes a first biometric input and a second biometric input, and wherein the method further comprises:
assigning a first risk index level to the first biometric input and assigning a second risk index level to the second biometric input;
combining the first and second risk index levels; and
determining that the biometric input for the user exceeds the risk threshold level in the user profile based on the combined first and second risk index levels.
